(19) United States
(12) Patent Application Publication
(10) Pub. No.: US 2010/0306486 A1
(43) Pub. Date: Dec. 2, 2010

(54) POLICY-BASED APPLICATION AWARE STORAGE ARRAY SNAPSHOT BACKUP AND RESTORE TECHNIQUE

(76) Inventors: SRIDHAR BALASUBRAMANIAN, Wichita, KS (US); Kenneth Fugate, Wichita, KS (US); Russell J. Henry, Wichita, KS (US)

Correspondence Address: GLOBAL IP SERVICES, PLLC, 10 CRESTWOOD LANE, NASHUA, NH, 03062, US

(21) Appl. No.: 12/474,280

(22) Filed: May 29, 2009

(51) Int. Cl. G06F 12/16; G06F 12/00

(52) U.S. Cl. 711/162; 719/318; 711/E12.001; 711/E12.103

(57) ABSTRACT

A method and system for performing a policy-based backup and recovery operation in a storage network is disclosed. In one embodiment, a method of performing a backup and restore operation in a storage network includes detecting each application entity in the storage network and configuring a backup and restore policy associated with the storage network for said each application entity. The storage network includes at least one host server and at least one storage array. The method also includes performing a backup operation of data associated with said each application entity based on the backup and restore policy using application utilities and operating system (OS) utilities configured to interface with said each application entity and a corresponding operating system of the at least one host server respectively, and using a storage array interface configured to directly interface with the at least one storage array.

### FIELD OF TECHNOLOGY

Embodiments of the present invention relate to the field of electronics. More particularly, embodiments of the present invention relate to a storage backup and restore technique.

### BACKGROUND

A backup operation refers to making copies of data, and a restore or recovery operation refers to recovering lost data using the copies of data obtained from the backup. The backup operation may be used to restore a state following a disaster or to restore lost files after they have been accidentally deleted or corrupted. When new data is generated and/or changes are made to existing data, the copies of data may need to be updated. Once the backup operation is completed, a success or failure of the backup operation may be verified and/or one or more recovery or restore points may be generated for a disaster recovery purpose at a later time.

Currently, backup and restore solutions may be based on server-agent architecture. That is, for every operating system (OS)/application type, a dedicated agent mechanism may be required for deployment. Thus, the solutions may be more application-centric. Additionally, the solutions can neither interface directly to a storage array in order to perform array related functions nor offer portability to a multiple application/OS environment. That is, the solutions may handle one application/OS instance per installation. Furthermore, the solutions may not offer automatic configuration of a backup scheme associated with the storage array.

### SUMMARY

A policy-based application aware storage array snapshot backup and restore technique is disclosed. In one aspect, a method of performing a backup and restore operation in a storage network (e.g., including at least one host server and at least one storage array) includes detecting each application entity in the storage network, and configuring a backup and restore policy associated with the storage network for said each application entity. The method further includes performing a backup operation of data associated with said each application entity based on the backup and restore policy.

The backup operation may be performed using application utilities and operating system (OS) utilities configured to interface with said each application entity and a corresponding operating system of the at least one host server respectively, and using a storage array interface configured to directly interface with the at least one storage array. The method also includes executing an integrity check for the backup operation by comparing the data associated with said each application entity with respective backed-up data using the application utilities.

Further, the method includes creating a recovery point based on the backed-up data, updating a local repository for the backup and restore policy, and posting application and OS logs to indicate a completion of the backup operation. Furthermore, the method includes presenting a set of recovery points for said each application entity in a disaster recovery situation. Moreover, the method includes performing a recovery operation of said each application entity based on a recovery point selected from the set of recovery points. In addition, the method includes verifying an integrity of the recovery operation for said each application entity using the application utilities and the OS utilities.

In another aspect, a policy-based backup and restore system includes a plurality of host servers and a plurality of storage arrays. Each of the plurality of host servers includes at least one application. The plurality of storage arrays is coupled to the plurality of host servers via a network. The policy-based backup and restore system also includes a policy-based backup and restore module in a system server coupled to the storage network. The policy-based backup and restore module performs a backup and restore operation associated with each one of the at least one application in said each host server.

Further, the policy-based backup and restore module is configured to detect each application entity in the storage network. The policy-based backup and restore module includes application utilities for interfacing with said each application entity. The policy-based backup and restore module also includes OS utilities for interfacing with a corresponding OS of each of the plurality of host servers. Further, the policy-based backup and restore module includes a storage array interface for directly interfacing with the plurality of storage arrays.

The methods, apparatuses and systems disclosed herein may be implemented in any means for achieving various aspects, and other features will be apparent from the accompanying drawings and from the detailed description that follow.

### BRIEF DESCRIPTION OF THE DRAWINGS

Various preferred embodiments are described herein with reference to the drawings, wherein:

FIG. 1 illustrates a block diagram of an exemplary system with a policy-based backup and restore module, according to one embodiment;

FIG. 2 is an exploded view of the policy-based backup and restore module in FIG. 1, according to one embodiment;

FIG. 3 illustrates a flow diagram of an exemplary computer executable process for performing a policy-based backup and restore operation, according to one embodiment; and

FIG. 4 illustrates a process flow chart of an exemplary method for performing a policy-based backup and restore operation, according to one embodiment. The drawings described herein are for illustration purposes only and are not intended to limit the scope of the present disclosure in any way.

### DETAILED DESCRIPTION

A policy-based application aware storage array snapshot backup and restore technique is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims.

The terms ‘restore’ and ‘recovery’ are used interchangeably throughout the document.

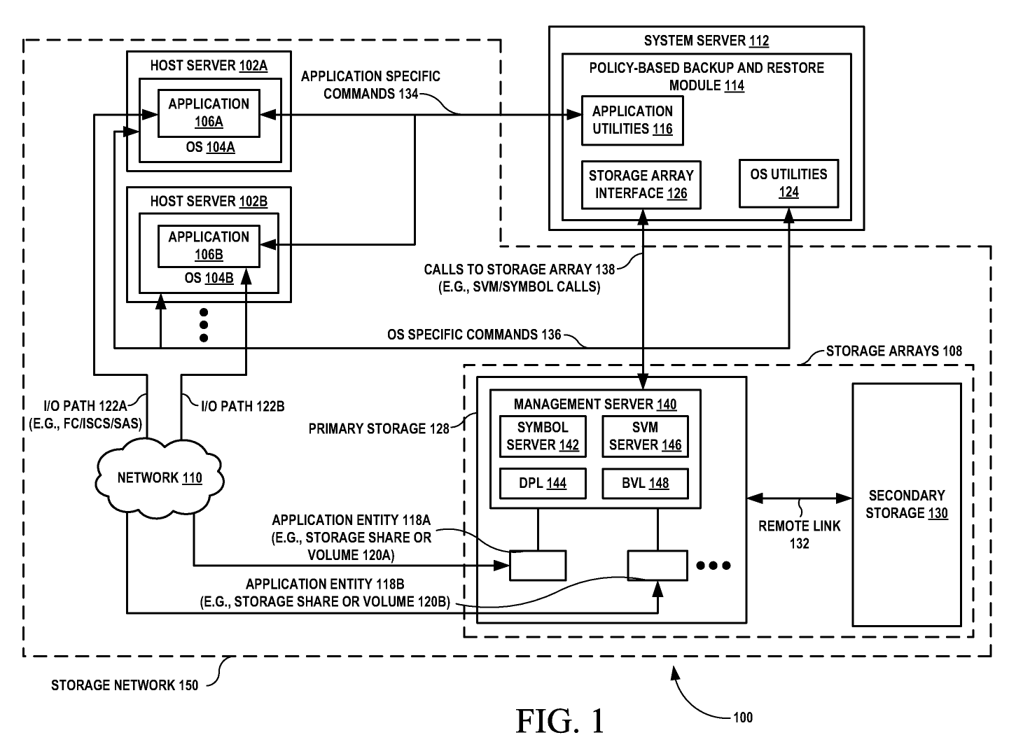

FIG. 1 illustrates a block diagram of an exemplary system 100 with a policy-based backup and restore module 114, according to one embodiment. Particularly, FIG. 1 illustrates the system 100 with the policy-based backup and restore module 114 in a system server 112 coupled to a storage network 150 for performing a backup and restore operation in the storage network 150. The storage network 150 includes a plurality of host servers 102A-N and a plurality of storage arrays 108.

As illustrated, the plurality of host servers 102A-N and the plurality of storage arrays 108 are coupled to each other via a network 110. Each of the plurality of host servers 102A-N includes an operating system (OS) 104 and an application 106. The plurality of storage arrays 108 reside in a primary storage 128 and a secondary storage 130 which are coupled via a remote link 132. As illustrated, the primary storage 128 includes a management server 140 that includes a symbol server 142, a data protection layer (DPL) 144, a storage virtualization manager (SVM) server 146 and a block virtualization layer (BVL) 148. In one example embodiment, the secondary storage 130 mirrors the primary storage 128.

The policy-based backup and restore module 114 includes application utilities 116, OS utilities 124 and a storage array interface 126 as illustrated in FIG. 1. The application utilities 116 are configured to interface with the application entities 118A, 118B, etc. For example, the application entity 118A may be an element within the application 106A and includes a storage share or volume 120A residing within the plurality of storage arrays 108. Additionally, another application entity 118B may be an element within the application 106B and includes another storage share or volume 120B residing within the plurality of storage arrays 108. It can be seen in FIG. 1 that, the application utilities 116 interface with the applications 106A-N using application specific commands 134. Further, the applications 106A-N interface with the application entities 118A-N using input/output paths 122A-N (e.g., fiber channel (FC)/internet small computer system interface (iSCS)/serial attached small computer system interface (SAS), etc.) via the network 110.

The OS utilities 124 are configured to interface with a corresponding OS 104 of each of the plurality of host servers 102A-N using OS specific commands 136. The storage array interface 126 directly interfaces with the plurality of storage arrays 108 using calls to storage array 138 (e.g., symbol/SVM calls). For example, the calls to storage array 138 helps accomplish storage arrays related functions such as expanding a volume, adding more capacity to an existing volume group, creating copies from backup sets, and so on. In one embodiment, the storage array interface 126 communicates with the symbol server 142 and the SVM server 146 within the plurality of storage arrays 108 to access to the DPL 144 and the BVL 148 respectively.

In accordance with the above mentioned embodiments, the policy-based backup and restore module 114 is configured to detect each application entity of the application entities 118A-N in the storage network 150. Further, the policy-based backup and restore module 114 configures a backup and restore policy associated with the storage network 150 for each of the application entities 118A-N. Based on the configured backup and restore policy and using the application utilities 116, the OS utilities 124 and the storage array interface 126, the policy-based backup and restore module 114 performs a backup and restore operation of data associated with each of the application entities 118A-N.

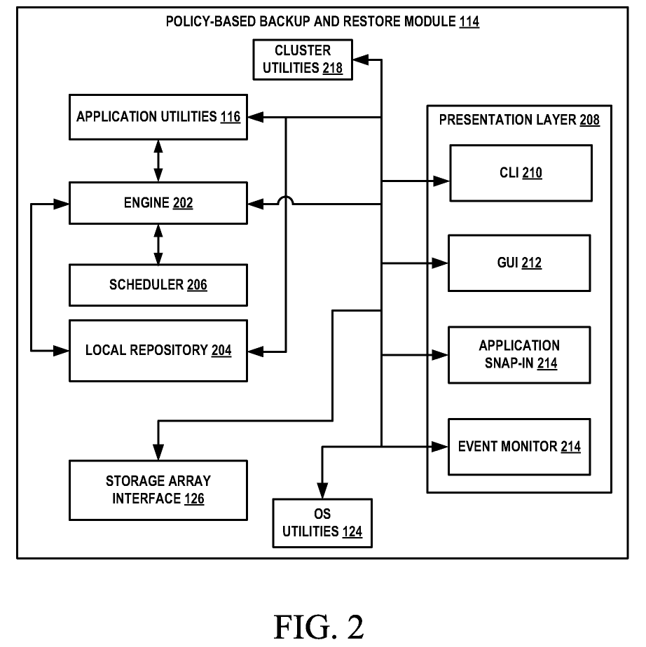

FIG. 2 is an exploded view of the policy-based backup and restore module 114 in FIG. 1, according to one embodiment. As illustrated, the policy-based backup and restore module 114 includes the application utilities 116, the OS utilities 124, the storage array interface 126, an engine 202, a local repository 204, a scheduler 206, a presentation layer 208 and cluster utilities 218.

In operation, the engine 202 performs functions and tasks associated with the policy-based backup and restore module 114. The local repository 204 is an internal relational database which maintains a record of the backup sets, time stamps, the application entities 118A-N, outcomes of the backup and restore operation, and schedules for the backup and restore operation. The scheduler 206 keeps track of the backup and restore operation in real time and executes the backup and restore operation associated with the application entities 118A-N that are scheduled to occur in real time.

As illustrated, the presentation layer 208 includes a command line interface (CLI) 210, a graphical user interface (GUI) 212, an application snap-in 214 and an event monitor 216. The CLI 210 is configured to support scripting the functions and tasks that a user may wish to perform. The GUI 212 is an application front-end for the user, configured to perform the required functions and tasks. The application snap-in 214 is configured to present the policy-based backup and restore module 114 as a widget on each of the applications 106A-N in the GUI 212. The event monitor 216 is configured to post event logs associated with the backup and restore operation. The cluster utilities 218 provide cluster intelligence and nodal discovery aspects (e.g., detection of nodal failures, cluster heartbeat mechanism, etc.) to the policy-based backup and restore module 114.

In accordance with the above mentioned embodiments, the application utilities 116 are configured to prepare the application entities 118A-N prior to backup/restore operation and to perform post backup operation tasks and post recovery operation tasks. The OS utilities 124 are configured to function as a set of commands that are directly passed to an OS 104 to perform a set of tasks such as mounting/dismounting of a volume, file system maintenance, etc. Moreover, the storage array interface 126 is configured to send and receive commands directly to the storage arrays 108.

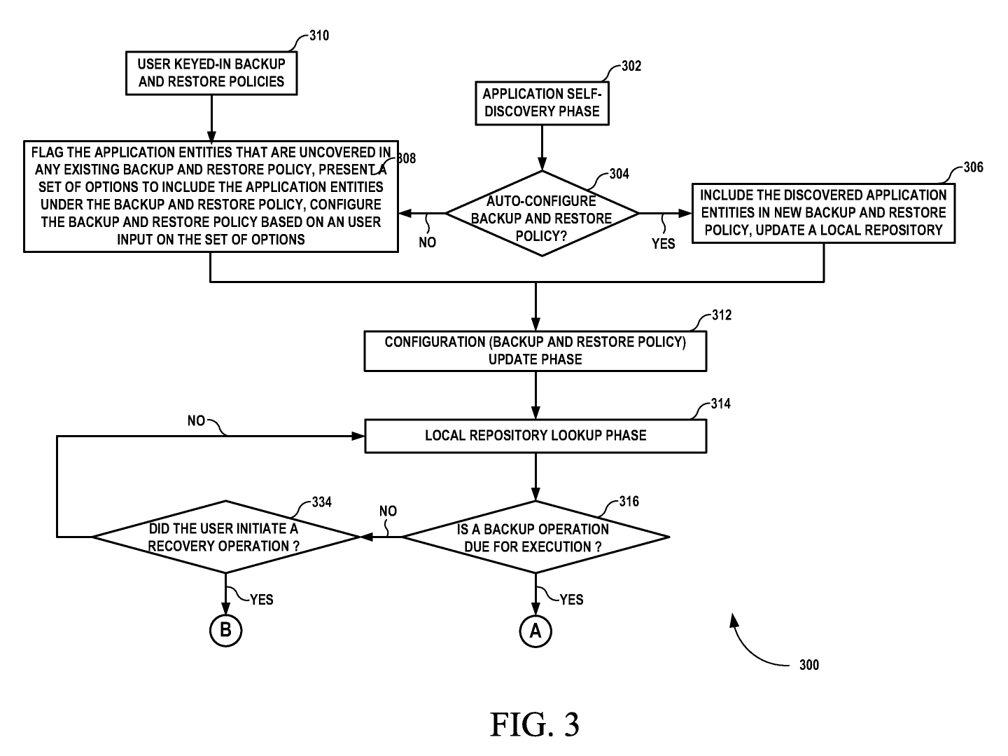

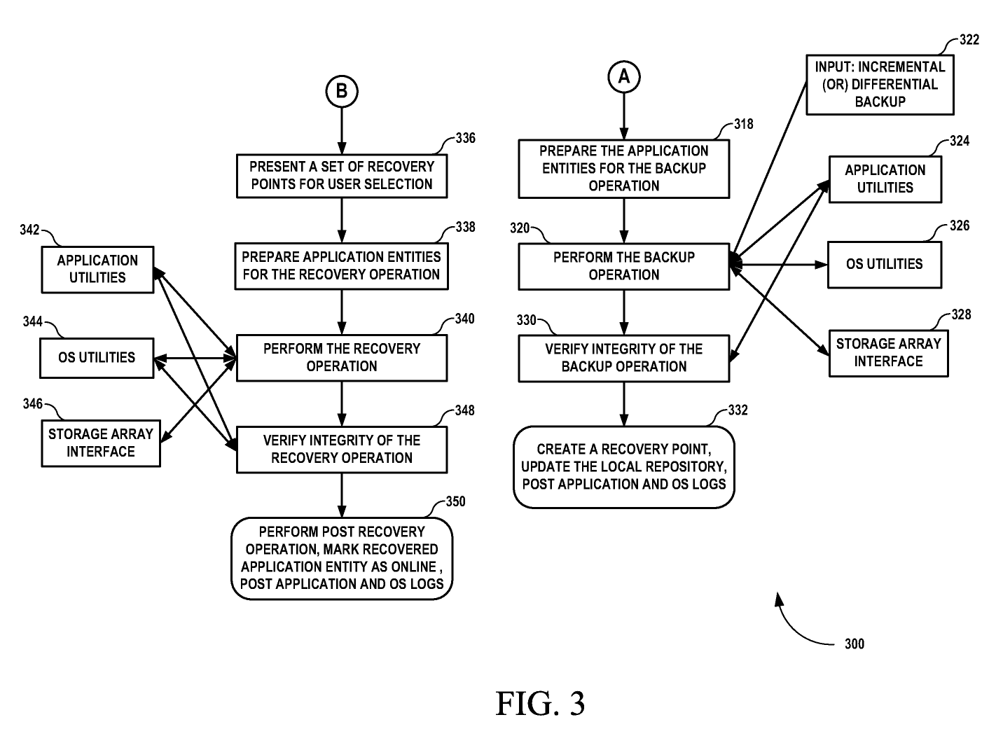

FIG. 3 illustrates a flow diagram of an exemplary computer executable process 300 for performing a policy-based backup and restore operation, according to one embodiment. In one embodiment, the policy-based backup and restore operation may be performed in a storage network which includes a plurality of host servers and a plurality of storage arrays.

In step 302, application entities with environment specifics in the storage network are discovered (e.g., an application self-discovery phase). In step 304, it is determined whether or not an auto-configure backup and restore policy is enabled. If it is determined that the auto-configure backup and restore policy is enabled, the process 300 performs step 306, else the process 300 performs step 308. In step 306, the discovered application entities are included in a new backup and restore policy and a local repository is updated.

In step 308, the application entities that are uncovered by any existing backup and restore policy are flagged. Further, in step 308, a set of options is presented to a user to include the application entities under the backup and restore policy. The backup and restore policy is then configured based on an user input on the set of options (e.g., a configuration phase). Furthermore, the step 308 is performed based on user keyed-in backup and restore policies (step 310). In step 312, the configured backup and restore policies are updated in the local repository (e.g., a configuration (backup and restore policy) update phase). The step 312 is performed based on step 306 and step 308.

Once the local repository is updated, an internal lookup within the local repository is performed in step 314 (e.g., a local repository lookup phase). In step 316, it is determined whether or not a backup operation is due for execution. If it is determined that a backup operation is due for execution, then the process 300 performs step 318. In step 318, the application entities are prepared for backup operation (e.g., a backup preparation phase).

In step 320, the backup operation is performed (e.g., a backup phase). In one embodiment, the backup operation may be an incremental or a differential backup operation 322. Further, the backup operation of data associated with the application entities may be performed based on the backup and restore policy using application utilities 324 and OS utilities 326 configured to interface with the application entities and a corresponding OS of each of the plurality of host servers respectively, and using a storage array interface 328 configured to interface directly with the plurality of storage arrays.

In step 330, an integrity of the backup operation is verified by comparing the data associated with the application entities with respective backed-up data using the application utilities 324 (e.g., a backup integrity validation phase). In step 332, a recovery point is created based on the backed-up data. Further, in step 332, the local repository is updated for the backup and restore policy, and application and OS logs are posted to indicate a completion of the backup operation (e.g., a local repository update phase).

If, in step 316, it is determined that a backup operation is not due for execution, then the process 300 performs step 334. In step 334, it is determined whether or not a recovery operation of application entities is initiated by the user based on a need or due to a disaster recovery situation. If it is determined not, the process 300 is routed back to step 314, else the process 300 performs step 336. In step 336, a set of recovery points for the application entities is presented to the user for selection. In step 338, the application entities are prepared for the recovery operation (e.g., a recovery preparation phase).

In step 340, the recovery operation of the application entities is performed based on a recovery point selected by the user from the set of recovery points (e.g., a recovery phase). For example, the recovery operation is performed by generating copies or mirrors from the backup sets using application utilities 342, OS utilities 344 and a storage array interface 346. In step 348, an integrity of the recovery operation for the application entities is verified using the application utilities 342 and the OS utilities 344 (e.g., a recovery integrity validation phase). In step 350, post recovery operation of the application entities is performed and the recovered application entities are marked as online using the application utilities 342 and the OS utilities 344. Further, in step 350, application and OS logs are posted to indicate a completion of the recovery operation.

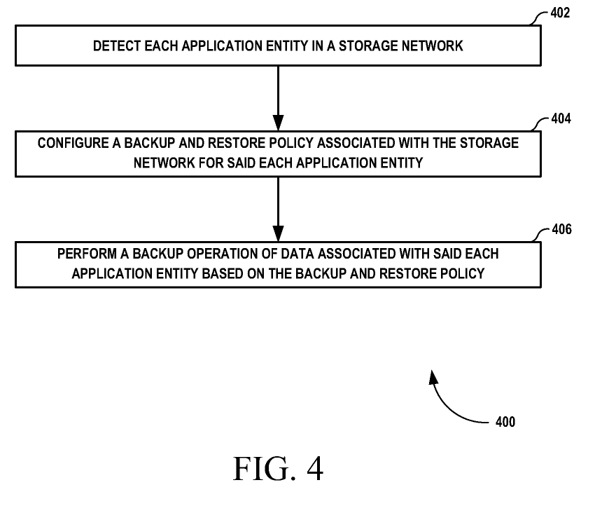

FIG. 4 illustrates a process flow chart of an exemplary method 400 for performing a policy-based backup and restore operation, according to one embodiment. In one embodiment, the policy-based backup and restore operation may be performed in a storage network that includes a plurality of host servers and a plurality of storage arrays. In step 402, each application entity in the storage network is detected. For example, said each application entity includes a storage share or volume residing within the plurality of storage arrays.

In step 404, a backup and restore policy associated with the storage network is configured for said each application entity. In one embodiment, the backup and restore policy is automatically configured to include an application entity if the application entity is uncovered by the backup and restore policy. In alternate embodiment, the backup and restore policy is configured by flagging the application entity which is uncovered by the backup and restore policy, and presenting a set of options to include the application entity under the backup and restore policy. The backup and restore policy is then configured based on an user input on the set of options.

In step 406, a backup operation of data associated with said each application entity is performed based on the backup and restore policy. In one embodiment, the backup operation is performed using application utilities and OS utilities, and using a storage array interface. It is appreciated that, the backup operation of the data is initiated based on a backup schedule defined in the backup and restore policy.

In accordance with the above-described embodiments, the method 400 may include executing an integrity check for the backup operation by comparing the data associated with said each application entity with respective backed-up data using the application utilities. The method 400 may also include creating a recovery point based on the backed-up data, updating a local repository for the backup and restore policy, and posting application and OS logs to indicate a completion of the backup operation.

Further, the method 400 may include presenting a set of recovery points for said each application entity in a disaster recovery situation. In one embodiment, a recovery operation of said each application entity is performed based on a recovery point selected from the set of recovery points. Additionally, the method 400 may include verifying integrity of the recovery operation for said each application entity using the application utilities and the OS utilities.

Moreover, in one example embodiment, a computer readable medium for performing a policy-based backup and restore operation in the storage network has instructions that, when executed by a computer, cause the computer to perform the method illustrated in FIG. 4.

In various embodiments, the policy-based backup and restore technique is portable across any OS and any application and is compatible with a wide range of OS and application databases. The above-described policy-based backup and restore system is capable of self discovering application entities upon deployment. Further, the above-described technique automatically configures a backup and restore policy for the application entities that are uncovered by existing backup and restore policies. The above-described technique is also capable of running on a local application server or from a remote host server. In addition, the above-described technique is self-sufficient in terms of fulfilling all disaster recovery requirements and not dependent on third party applications for backup and restore tasks.

Moreover, the above-described technique includes an internal database that keeps track of backup operation, recovery points, etc. This enables a user(s) to select from during a disaster recovery process. In one embodiment, the above-described policy-based backup and restore technique provides policy-based non-destructive backup and quick restore functionality. Further, above-described policy-based backup and restore technique supports external backup and application interfaces, provides backup/restore integrity validation and supports disaster recovery process via provisioning to generate copies/mirrors from backup sets.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., complementary metal oxide semi-conductor based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated circuitry (ASIC)).

What is claimed is:

1. A method for performing a backup and restore operation in a storage network, comprising:
detecting each application entity in the storage network, wherein the storage network comprises at least one host server and at least one storage array;
configuring a backup and restore policy associated with the storage network for said each application entity; and
performing a backup operation of data associated with said each application entity based on the backup and restore policy using application utilities and operating system (OS) utilities configured to interface with said each application entity and a corresponding operating system of the at least one host server respectively, and using a storage array interface configured to directly interface with the at least one storage array.

2. The method of claim 1, wherein the application entity comprises a storage share or volume residing within the at least one storage array.

3. The method of claim 1, wherein the configuring the backup and restore policy comprises automatically configuring the backup and restore policy to include an application entity if the application entity is uncovered by the backup and restore policy.

4. The method of claim 1, wherein the configuring the backup and restore policy comprises:
flagging an application entity which is uncovered by the backup and restore policy;
presenting a set of options to include the application entity under the backup and restore policy; and
configuring the backup and restore policy based on user input on the set of options.

5. The method of claim 1, wherein the performing the backup operation of the data is initiated based on a backup schedule defined in the backup and restore policy.

6. The method of claim 1, further comprising executing an integrity check for the backup operation by comparing the data associated with said each application entity with respective backed-up data using the application utilities.

7. The method of claim 6, further comprising:
creating a recovery point based on the backed-up data;
updating a local repository for the backup and restore policy; and
posting application and operating system logs to indicate a completion of the backup operation.

8. The method of claim 1, further comprising presenting a set of recovery points for said each application entity in a disaster recovery situation.

9. The method of claim 8, further comprising performing a recovery operation of said each application entity based on a recovery point selected from the set of recovery points.

10. The method of claim 9, further comprising verifying an integrity of the recovery operation for said each application entity using the application utilities and the operating system utilities.

11. A policy-based backup and restore system, comprising:
a plurality of host servers with each host server having at least one application;
a plurality of storage arrays coupled to the plurality of host servers via a network; and
a policy-based backup and restore module in a system server coupled to the storage network for performing a backup and restore operation associated with each one of the at least one application in said each host server, wherein
the policy-based backup and restore module is configured to detect each application entity in the storage network; wherein the policy-based backup and restore module comprises application utilities for interfacing with said each application entity; wherein the policy-based backup and restore module comprises operating system utilities for interfacing with a corresponding operating system of each of the plurality of host servers;
and wherein the policy-based backup and restore module comprises a storage array interface for directly interfacing with the plurality of storage arrays.

12. The system of claim 11, wherein the policy-based backup and restore module comprises:
an engine for performing a plurality of functions and tasks associated with the policy-based backup and restore module;
a local repository for maintaining a record of backup sets, time stamps, said each application entity, outcome of the backup and restore operation, and schedules for the backup and restore operation; and
a scheduler for keeping track of the backup and restore operation in real time.

13. The system of claim 11, wherein the policy-based backup and restore module comprises a presentation layer which includes:
a command line interface;
a graphical user interface;
an application snap-in for presenting the policy-based backup and restore module as a widget on said each one of the at least one application; and
an event monitor for posting event logs associated with the backup and restore operation.

14. The system of claim 11, wherein the policy-based backup and restore module comprises cluster utilities for providing cluster intelligence and nodal discovery aspects to the policy-based backup and restore module.

15. The system of claim 11, wherein the plurality of storage arrays reside in a primary storage and a secondary storage.

16. The system of claim 11, wherein the application utilities interface with said each application entity using application specific commands for said each application entity.

17. The system of claim 11, wherein the operating system utilities interface with said each host server using operating system specific commands which correspond to an operating system of said each host server.

18. The system of claim 11, wherein the application entity comprises a storage share or volume residing within the plurality of storage arrays.

19. A computer readable medium for performing a policy-based backup and restore operation in a storage network having instructions that, when executed by a computer, cause the computer to perform a method comprising:
detecting each application entity in the storage network, wherein the storage network comprises at least one host server and at least one storage array;
configuring a backup and restore policy associated with the storage network for said each application entity; and
performing a backup operation of data associated with said each application entity based on the backup and restore policy using application utilities and operating system (OS) utilities configured to interface with said each application entity and a corresponding operating system of the at least one host server respectively, and using a storage array interface configured to directly interface with the at least one storage array.

20. The computer readable medium of claim 19, wherein the configuring the backup and restore policy comprises automatically configuring the backup and restore policy to include an application entity if the application entity is uncovered by the backup and restore policy.
